(19) United States
(12) Patent Application Publication
(10) Pub. No.: US 2014/0179833 A1
(43) Pub. Date: Jun. 26, 2014

(54) EPOXY RESIN COMPOSITION FOR ENCAPSULATION OF SEMICONDUCTOR DEVICE AND SEMICONDUCTOR DEVICE ENCAPSULATED USING THE SAME

(71) Applicants: Eun Jung LEE, Uiwang-si (KR); Jong Sung KIM, Uiwang-si (KR); Do Won JUNG, Uiwang-si (KR)

(72) Inventors: Eun Jung LEE, Uiwang-si (KR); Jong Sung KIM, Uiwang-si (KR); Do Won JUNG, Uiwang-si (KR)

(21) Appl. No.: 14/138,466

(22) Filed: Dec. 23, 2013

(30) Foreign Application Priority Data
Dec. 24, 2012 (KR) 10-2012-0152616

(51) Int. Cl. C08L 63/00

(52) U.S. Cl. CPC C08L 63/00
USPC 523/466

(57) ABSTRACT

A epoxy resin composition includes an epoxy resin including repeat units represented by Formulae 1 and 2; a curing agent; a curing accelerator; and an inorganic filler,

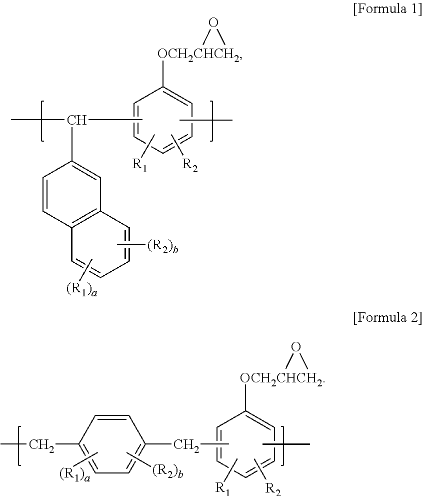

### CROSS-REFERENCE TO RELATED APPLICATION

Korean Patent Application No. 10-2012-0152616, filed on Dec. 24, 2012, in the Korean Intellectual Property Office, and entitled: “Epoxy Resin Composition For Encapsulation Of Semiconductor Device and Semiconductor Device Encapsulated Using The Same,” is incorporated by reference herein in its entirety.

### BACKGROUND

1. Field

Embodiments relate to an epoxy resin composition for encapsulation of a semiconductor device and a semiconductor device encapsulated using the same.

2. Description of the Related Art

An epoxy resin composition may be used for encapsulation of a semiconductor device.

In order to realize flame retardancy, a general epoxy resin composition for encapsulation of a semiconductor device may be prepared using a brominated epoxy resin.

### SUMMARY

Embodiments are directed to an epoxy resin composition for encapsulation of a semiconductor device, the epoxy resin composition including an epoxy resin including repeat units represented by Formulae 1 and 2; a curing agent; a curing accelerator; and an inorganic filler,

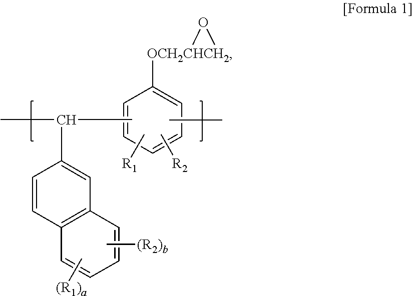

wherein, in Formula 1, R₁ and R₂ may each independently be hydrogen or a linear or branched C1-C5 alkyl group, and a and b may each independently be an integer from 0 to 7,

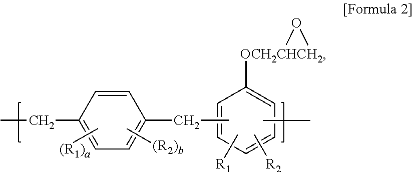

wherein, in Formula 2, R₁ and R₂ may each independently be hydrogen or a linear or branched C1-C5 alkyl group, and a and b may each independently be an integer from 0 to 4.

The epoxy resin may be a naphthalene group and phenyl group-containing phenolaralkyl type epoxy resin represented by Formula 3:

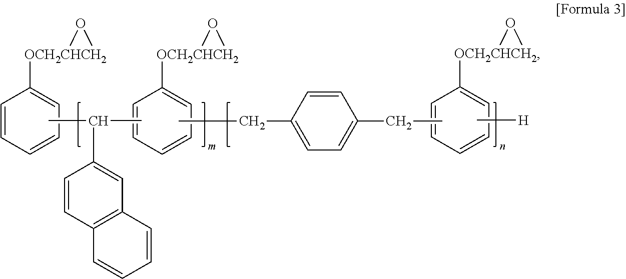

wherein, in Formula 3, m and n may each independently be on average from 1 to 10.

In Formula 3, m/(m+n) may range from about 0.1 to about 0.9, and n/(m+n) may range from about 0.1 to about 0.9.

The epoxy resin may include the repeat units of Formulae 1 and 2 in a molar ratio of about 10:90 to about 90:10.

The epoxy resin may include the repeat units of Formulae 1 and 2 in a molar ratio of about 90:10 to about 30:70.

The epoxy resin may have an epoxy equivalent weight of about 100 g/eq. to about 250 g/eq., and a melt viscosity of about 0.1 poise to about 3 poise at 150° C.

The epoxy resin may be present in an amount of about 1% by weight (wt %) to about 13 wt % in the epoxy resin composition.

The curing agent may include at least one of a phenolaralkyl type phenol resin and a xylok type phenol resin.

The epoxy resin composition may include: about 1 wt % to about 13 wt % of the epoxy resin; about 1.5 wt % to about 10 wt % of the curing agent; about 0.001 wt % to about 1.5 wt % of the curing accelerator; and about 70 wt % to about 94 wt % of the inorganic filler.

The epoxy resin composition may further include a second epoxy resin selected from the group of a phenolaralkyl type epoxy resin having a biphenyl backbone represented by Formula 4, a biphenyl type epoxy resin represented by Formula 5, and a xylok type epoxy resin represented by Formula 6,

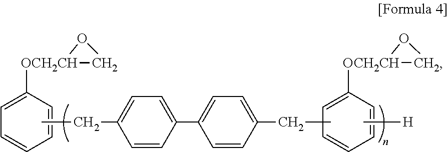

wherein, in Formula 4, n may be a value from 1 to 7 on average.

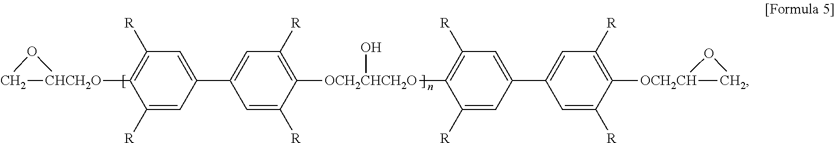

wherein, in Formula 5, R may be a C1 to C4 alkyl group, and n may be a value from 0 to 7 on average,

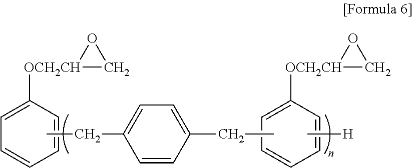

wherein, in Formula 6, n may be a value from 1 to 7 on average.

The epoxy resin and the curing agent may be present in an amount such that an equivalent weight ratio of an epoxy group in the epoxy resin to a phenolic hydroxyl group in the curing agent ranges from about 0.5:1 to about 2:1.

The curing accelerator may be a tertiary amine, an organometallic compound, an organophosphorus compound, an imidazole compound, or a boron compound.

The inorganic filler may include about 50 wt % to about 99 wt % of fused spherical silica having an average particle diameter of about 5 μm to about 30 μm and about 1 wt % to about 50 wt % of fused spherical silica having an average particle diameter of about 0.001 μm to about 1 μm.

Embodiments are also directed to a semiconductor device encapsulated using an epoxy resin composition according to an embodiment.

### DETAILED DESCRIPTION

Example embodiments will now be described more fully hereinafter; however, they may be embodied in different forms and should not be construed as limited to the embodiments set forth herein. Rather, these embodiments are provided so that this disclosure will be thorough and complete, and will fully convey exemplary implementations to those skilled in the art.

According to an example embodiment, an epoxy resin composition for encapsulation of a semiconductor device includes an epoxy resin (A), a curing agent (B), a curing accelerator (C), and an inorganic filler (D).

(A) Epoxy Resin

According to the present example embodiment, the epoxy resin is a naphthalene group and phenyl group-containing phenolaralkyl type epoxy resin having repeat units represented by Formulae 1 and 2.

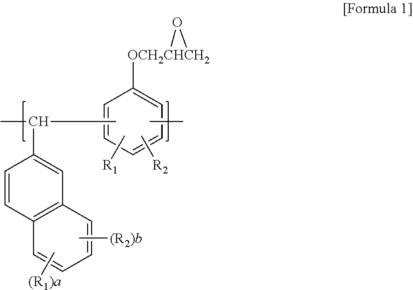

According to the present example embodiment, in Formula 1, R₁ and R₂ are each independently hydrogen or a linear or branched C1-C5 alkyl group, and a and b are an integer from 0 to 7.

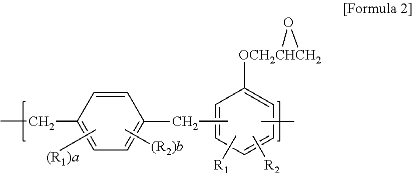

According to the present example embodiment, in Formula 2, R₁ and R₂ are each independently hydrogen or a linear or branched C1-C5 alkyl group, and a and b are an integer from 0 to 4.

The naphthalene group and phenyl group-containing phenolaralkyl type epoxy resin (A) may include the repeat units represented by Formulae 1 and 2 in a molar ratio of about 10:90 to about 90:10, which may help secure flame retardancy together with excellent warpage properties. For example, the repeat units represented by Formulae 1 and 2 may be included in a molar ratio of about 90:10 to about 30:70.

According to an example embodiment, the naphthalene group and phenyl group-containing phenolaralkyl type epoxy resin (A) may be represented by Formula 3:

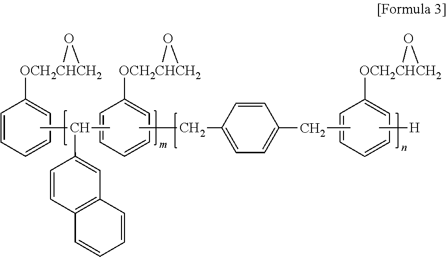

According to the present example embodiment, in Formula 3, m and n are each independently on average from 1 to 10.

In an example embodiment, m/(m+n) may range from about 0.1 to about 0.9, and n/(m+n) may range from about 0.1 to about 0.9. For example, m/(m+n) may range from about 0.3 to about 0.9, and n/(m+n) may range from about 0.1 to about 0.7.

The naphthalene group and phenyl group-containing phenolaralkyl type epoxy resin may have high cross-linking density, high glass transition temperature and low curing shrinkage, which may help provide excellent warpage properties. The epoxy resin may include naphthalene and phenyl derivatives, and may have excellent moisture absorption resistance, toughness, and crack resistance. Further, the epoxy resin may easily form a char layer upon combustion regardless of high cross-linking density. Thus, the epoxy resin may provide excellent flame retardancy, as compared with other epoxy resins having a similar glass transition temperature.

According to an example embodiment, the naphthalene group and phenyl group-containing phenolaralkyl type epoxy resin has an epoxy equivalent weight of about 100 g/eq.

to about 250 g/eq. Within this range, the epoxy resin composition may exhibit excellent balance among curing shrinkage, curability, and flowability. For example, the epoxy resin may have an epoxy equivalent weight of about 120 g/eq. to about 160 g/eq.

The naphthalene group and phenyl group-containing phenolaralkyl type epoxy resin may have a softening point of about 40° C. to about 120° C. The epoxy resin may have a melt viscosity of about 0.1 poise to about 3 poise at 150° C. Within the melt viscosity range, the epoxy resin composition may exhibit sufficient flowability upon melting, and the moldability of the epoxy resin composition may be maintained.

The naphthalene group and phenyl group-containing phenolaralkyl type epoxy resin may be present in an amount of about 1 wt % to about 13 wt % in the epoxy resin composition. Within this range, the epoxy resin composition may have excellent flowability, flame retardancy, adhesion, and reliability. For example, the biphenyl group-containing phenolaralkyl type epoxy resin may be present in an amount of about 2 wt % to about 9 wt %.

The epoxy resin composition of the present example embodiment may further include a second epoxy resin. The second epoxy resin may be present in an amount of about 30 wt % or more in the epoxy resin composition. Within this range, the epoxy resin composition may have suitable properties in terms of curing shrinkage, excellent adhesion, reliability, and flowability. The second epoxy resin may be present in an amount of about 50 wt % or more, e.g., about 60 wt % to about 100 wt %, in the epoxy resin composition.

In an implementation, the second epoxy resin contains two or more epoxy groups. The second epoxy resin may include one or more of monomers, oligomers, or polymers.

Examples of the second epoxy resin may include phenolaralkyl type epoxy resins, ortho-cresol novolac type epoxy resins, epoxy resins obtained by epoxidation of a condensate of a phenol (including alkyl phenols) with hydroxybenzaldehyde, phenol novolac type epoxy resins, cresol novolac type epoxy resins, polyfunctional epoxy resins, naphthol novolac type epoxy resins, novolac type epoxy resins of bisphenol A/bisphenol F/bisphenol AD, glycidyl ethers of bisphenol A/bisphenol F/bisphenol AD, bishydroxybiphenyl epoxy resins, dicyclopentadiene epoxy resins, biphenyl epoxy resins, polyaromatic modified epoxy resins, bisphenol A epoxy resins, naphthalene epoxy resins, etc.

In an example embodiment, the second epoxy resin is a phenolaralkyl type epoxy resin having a biphenyl backbone represented by Formula 4, a biphenyl type epoxy resin represented by Formula 5, or a xylok type epoxy resin represented by Formula 6.

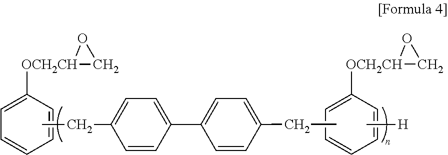

According to the present example embodiment, in Formula 4, n is a value from 1 to 7 on average.

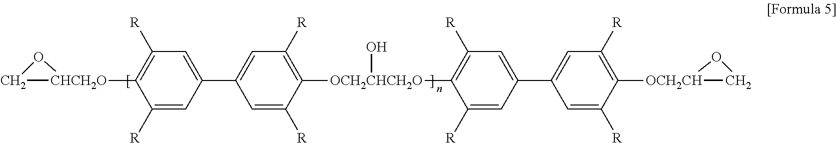

According to the present example embodiment, in Formula 5, R is a C1 to C4 alkyl group, and n is a value from 0 to 7 on average.

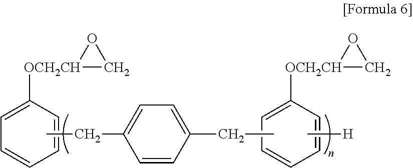

According to the present example embodiment, in Formula 6, n is a value from 1 to 7 on average.

The epoxy resin may be also used as an adduct compound prepared by pre-reaction, such as a melt master batch reaction, of the epoxy resin with the curing agent, the curing accelerator and, e.g., release agents, coupling agents and the like.

According to an example embodiment, the epoxy resin may be present in an amount of about 1 wt % to about 13 wt % in the epoxy resin composition. Within this range, the epoxy resin composition may exhibit excellent properties in terms of flowability, flame retardancy, adhesion, and reliability. For example, the epoxy resin may be present in an amount of about 2 wt % to about 9 wt %.

(B) Curing Agent

According to an example embodiment, the curing agent contains two or more phenolic hydroxyl groups or amino groups, and the like. One or more of monomers, oligomers, or polymers may be employed as the curing agent.

Examples of the curing agent may include phenolaralkyl type phenol resins, xylok type phenol resins, phenol novolac type phenol resins, cresol novolac type phenol resins, naphthol type phenol resins, terpene type phenol resins, polyfunctional phenol resins, polyaromatic phenol resins, dicyclopentadiene phenol resins, terpene modified phenol resins, dicyclopentadiene modified phenol resins, novolac type phenol resins synthesized from bisphenol A and cresol, multivalent phenol compounds including tris(hydroxyphenyl)methane and dihydroxybiphenyl, acid anhydride including maleic anhydride and phthalic anhydride, metaphenylene diamine, diamino diphenyl methane, diamino diphenylsulfone, etc.

For example, a phenolaralkyl type phenol resin having a biphenyl backbone represented by Formula 7, or a xylok type phenol resin represented by Formula 8 may be used as the curing agent.

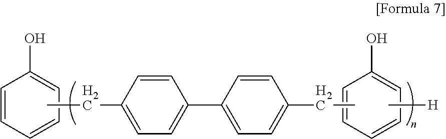

According to the present example embodiment, in Formula 7, n is a value from 1 to 7 on average.

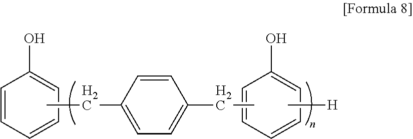

According to the present example embodiment, in Formula 8, n is a value from 1 to 7 on average.

The curing agent may be used alone or in combination thereof. For example, the curing agent may be used as an adduct compound prepared by pre-reaction, such as a melt master batch reaction, of the curing agent with the epoxy resin, a curing accelerator, and other additives and the like.

The curing agent may have a softening point of about 50° C. to about 100° C. Within this range, the curing agent may secure suitable resin viscosity without deteriorating flowability.

The phenolic hydroxyl group contained in the curing agent may have an equivalent weight from about 90 g/eq. to about 300 g/eq.

Further, the composition ratio of the epoxy resin to the curing agent may be selected such that an equivalent weight ratio of the epoxy group in the epoxy resin to the phenolic hydroxyl group in the curing agent ranges from about 0.5:1 to about 2:1. Within this range, the resin composition may secure flowability and the curing time is not delayed. For example, the equivalent weight ratio may range from about 0.8:1 to about 1.6:1.

The curing agent may be present in an amount of about 1.5 wt % to about 10 wt % in the epoxy resin composition. Within this range, the resin composition may have excellent reliability, and the unreacted epoxy group and phenolic hydroxyl group may not remain in large amount. For example, the curing agent may be present in an amount of about 2 wt % to about 8 wt % in the epoxy resin composition.

(C) Curing Accelerator

The curing accelerator accelerates reaction of the epoxy resin and the curing agent. Examples of the curing accelerator may include a tertiary amine, an organometallic compound, an organophosphorus compound, an imidazole compound, a boron compound, etc. For example, an organophosphorus compound may be used as the curing accelerator.

Examples of the tertiary amine may include benzyldimethylamine, triethanolamine, triethylenediamine, dimethylaminoethanol, tri(dimethylaminomethyl)phenol, 2,2-(dimethylaminomethyl)phenol, 2,4,6-tris(diaminomethyl)phenol, a salt of tri-2-ethylhexanoic acid, etc. Examples of the organometallic compound may include chromium acetylacetonate, zinc acetylacetonate, nickel acetylacetonate, etc. Examples of the organophosphorus compound may include tris-4-methoxyphosphine, tetrabutyl phosphonium bromide, butyl triphenyl phosphonium bromide, phenyl phosphine, diphenyl phosphine, triphenyl phosphine, triphenyl phosphine triphenyl borane, triphenyl phosphine-1,4-benzoquinone adduct, etc. Examples of the imidazole compound may include 2-methylimidazole, 2-phenylimidazole, 2-aminoimidazole, 2-methyl-1-vinylimidazole, 2-ethyl-4-methylimidazole, 2-heptadecylimidazole, etc. Examples of the boron compound may include tetraphenyl phosphonium tetraphenyl borate, triphenyl phosphine tetraphenyl borate, tetraphenyl borate, trifluoroborane-n-hexylamine, trifluoroborane monoethylamine, tetrafluoroborane triethylamine, tetrafluoroborane amine, etc. Additionally, 1,5-diazobicyclo[4.3.0]non-5-ene, 1,8-diazobicyclo[5.4.0]undec-7-ene, and phenolnovolac resin salt, and the like may be used.

In addition, the curing accelerator may be used in the form of an adduct compound prepared through pre-reaction with the epoxy resin and/or the curing agent.

The curing accelerator may be present in an amount of about 0.001 wt % to about 1.5 wt % in a total epoxy resin composition. Within this range, the time for curing reaction may not be delayed and flowability of the composition may be ensured. For example, the curing accelerator may be present in an amount of about 0.01 wt % to about 1 wt %.

(D) Inorganic Filler

The inorganic filler is used in the epoxy resin composition to improve mechanical properties and to reduce strain. Examples of the inorganic filler may include fused silica, crystalline silica, calcium carbonate, magnesium carbonate, alumina, magnesia, clay, talc, calcium silicate, titanium oxide, antimony oxide, glass fiber, etc. These may be used alone or in combination of two or more thereof.

For example, fused silica having a low coefficient of linear expansion may be used in order to reduce strain. The fused silica refers to non-crystalline silica having a specific gravity of 2.3 or less. Fused silica may be produced by melting crystalline silica or include non-crystalline silica synthesized from various materials.

The inorganic fillers may have various shapes and particle diameters. The inorganic fillers may have an average particle diameter of about 0.001 μm to about 30 μm. For example, the fused spherical silica may have an average particle diameter of about 0.001 μm to about 30 μm. As the inorganic filler, a mixture of fused spherical silica having different particle diameters may be used. For example, a mixture of about 50 wt % to about 99 wt % of fused spherical silica having an average particle diameter of about 5 μm to about 30 μm and about 1 wt % to about 50 wt % of fused spherical silica having an average particle diameter of about 0.001 μm to about 1 μm may be used. Further, a maximum particle diameter of the inorganic fillers may be adjusted to about 45 μm, about 55 μm, or about 75 μm, as needed.

The inorganic filler may be subjected to surface treatment using at least one coupling agent selected from the group of epoxysilane, aminosilane, mercaptosilane, alkylsilane, and alkoxysilane.

The inorganic filler may be included in a suitable ratio according to physical properties of the epoxy resin composition, such as moldability, low strain, high temperature strength, and the like. For example, the inorganic filler may be present in an amount of about 70 wt % to about 94 wt % in the epoxy resin composition. Within this range, the resin composition may exhibit excellent warpage properties and package reliability, and excellent flowability and moldability. For example, the inorganic filler may be present in an amount of about 82 wt % to about 92 wt % in the epoxy resin composition.

(E) Additive

The epoxy resin composition according to the present example embodiment may include additives such as coloring agents, release agents, strain relieve agents, crosslinking promoters, leveling agents, flame retardants, and the like.

Examples of the coloring agent may include carbon black, and organic or inorganic dyes, etc.

The coupling agent may be a silane coupling agent. The silane coupling agent may include one or more of epoxysilane, aminosilane, mercaptosilane, alkylsilane, alkoxysilane, etc.

The release agent may include one or more of paraffin wax, ester wax, higher fatty acid, higher fatty acid metal salts, natural fatty acid, natural fatty acid metal salts, etc.

The strain relaxation agent may include one or more of modified silicone oil, silicone elastomers, silicone powder, silicone resin, etc.

The additives may be present in an amount of about 0.1 wt % to about 5.5 wt % in the epoxy resin composition.

In another example embodiment, the epoxy resin composition may include a flame retardant. Examples of the flame retardant may include non-halogen organic or inorganic flame retardants. As non-halogen organic or inorganic flame retardants, flame retardants such as phosphagens, zinc borate, aluminum hydroxide, magnesium hydroxide, and the like may be used, etc. Flame retardancy may vary depending on the content of the inorganic fillers and the sort of the curing agents. Thus, the flame retardant may be included in the epoxy resin composition in a suitable ratio according to a desired level of flame retardancy. In an implementation, the flame retardant may be present in an amount of about 10 wt % or less, e.g., about 8 wt % or less, or about 5 wt % or less, in the epoxy resin composition. The epoxy resin composition according to the present example embodiment may have excellent glass transition temperature, low curing shrinkage, excellent package warpage properties, excellent adhesion to various other materials constituting the semiconductor package, high moisture absorption resistance, and excellent reliability, while ensuring excellent flame retardancy without using a halogen flame retardant.

According to an example embodiment, the epoxy resin composition may be prepared by, e.g., homogenizing the components using a Henschel mixer or a Ploughshare mixer, followed by melt kneading at about 90° C. to about 120° C. using a roll mill or a kneader, and then cooling and crushing.

According to an example embodiment, a semiconductor device may be encapsulated using an epoxy resin composition according to an embodiment.

According to an example embodiment, encapsulation of a semiconductor device using the epoxy resin composition may be realized by, e.g., low-pressure transfer molding. Compression molding, injection molding, or cast molding may also be used for encapsulation of the semiconductor device using the epoxy resin composition. By such a process, semiconductor devices including a copper lead frame, an iron lead frame, or a lead frame obtained by free plating at least one selected from nickel, copper and palladium to the lead frame, or an organic laminate frame may be produced.

According to an example embodiment, encapsulating a semiconductor package may include, e.g., selection of a suitable molding machine, encapsulation molding and curing of a semiconductor device package using the prepared epoxy resin composition in the molding machine, and post-molding curing of the molded semiconductor device package. Encapsulation molding may be performed at about 160° C. to about 190° C. for about 40 seconds to about 300 seconds, and post-molding curing may be performed at about 160° C. to about 190° C. for about 0 to about 8 hours.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLES

Details of the components used in Examples and Comparative Examples were as follows.

(A) Epoxy Resin

(a1) An epoxy resin having an epoxy equivalent weight of 141 g/eq., a viscosity of 1.1 poise at 150° C., a softening point of 58° C., a structure of Formula 3, m/(m+n) of 0.5, and n/(m+n) of 0.5 was used.

(a2) An epoxy resin having an epoxy equivalent amount of 138 g/eq., a viscosity of 0.94 poise at 150° C., a softening point of 58° C., a structure of Formula 3, m/(m+n) and n/(m+n) of 0.3 and 0.7, respectively, was used.

(a3) An epoxy resin having an epoxy equivalent amount of 146 g/eq., a viscosity of 1.42 poise at 150° C., a softening point of 64° C., a structure of Formula 3, m/(m+n) and n/(m+n) of 0.9 and 0.1, respectively, was used.

(a4) An epoxy resin having an epoxy equivalent amount of 221 g/eq., a viscosity of 1.5 poise at 150° C., a softening point of 65° C., and an n value of 0 in Formula 3 was used.

(a5) An epoxy resin, NC-3000 (Nippon Kayaku K.K.) wherein m in Formula 3 is 0, was used.

(B) Curing Agent

(b1) A phenolaralkyl type phenol resin: HE200C-10 (Air Water Co., Ltd.) was used.

(b2) A xylok type phenol resin: HE100C-10 (Air Water Co., Ltd.) was used.

(C) Curing Accelerator:

Triphenylphosphine, TPP (Hokko Co., Ltd.), was used.

(D) Inorganic filler:

A mixture of fused spherical silica having an average particle diameter of 18 μm and fused spherical silica having an average particle diameter of 0.5 μm in a weight ratio of 9:1 was used. The inorganic filler was present in an amount of 87 wt % in the rein composition.

(E) Coupling Agent

(e1) 3-glycidoxypropyl trimethoxysilane S-510 (Chisso Co., Ltd.) was used.

(F) Additive

(f1) Carnauba wax as a release agent, and (f2) carbon black, MA-600 (Matsushita Chemical Co., Ltd.) as a coloring agent, were used.

### Examples 1 to 5 and Comparative Examples 1 to 3

The components were weighed in amounts as listed in Table 1 and homogenized using a Henschel mixer to prepare a primary composition in powder state. Subsequently, the composition was melt kneaded at 95° C. using a continuous kneader, followed by cooling and crushing to prepare an epoxy resin composition for encapsulation of a semiconductor device.

TABLE 1

| | | | | | | | Comparative | | |
|---|---|---|---|---|---|---|---|---|---|
| | | Examples | | | | | Examples | | |
| Components | | 1 | 2 | 3 | 4 | 5 | 1 | 2 | 3 |
| Epoxy resin | (a1) | 4.80 | 5.22 | — | — | — | — | — | — |
| | (a2) | — | — | 4.73 | 5.16 | — | — | — | — |
| | (a3) | — | — | — | — | 4.89 | — | — | — |
| | (a4) | — | — | — | — | — | 6.10 | 6.53 | — |
| | (a5) | — | — | — | — | — | — | — | 5.84 |
| Curing agent | (b1) | 6.90 | — | 6.97 | — | 6.81 | 5.60 | — | 5.86 |
| | (b2) | — | 6.48 | — | 6.54 | — | — | 5.17 | — |
| (C) Curing accelerator | | 0.5 | 0.5 | 0.5 | 0.5 | 0.5 | 0.5 | 0.5 | 0.5 |
| (D) Inorganic filler | | 87 | 87 | 87 | 87 | 87 | 87 | 87 | 87 |
| (E) Coupling agent | (e1) | 0.2 | 0.2 | 0.2 | 0.2 | 0.2 | 0.2 | 0.2 | 0.2 |
| (F) Additive | (f1) | 0.3 | 0.3 | 0.3 | 0.3 | 0.3 | 0.3 | 0.3 | 0.3 |
| | (f2) | 0.3 | 0.3 | 0.3 | 0.3 | 0.3 | 0.3 | 0.3 | 0.3 |

(Unit: wt %)

Evaluation of Physical Properties

(1) Flowability (inch): Flow length was measured at 175° C. and 70 kgf/cm² using a transfer molding press and an evaluation mold in accordance with EMMI-1-66. A higher value indicated better flowability.

(2) Curing shrinkage (%): A molding specimen (125×12.6×6.4 mm) was prepared using an ASTM mold for preparation of flexural strength specimens and using a transfer molding press at 175° C. and 70 kgf/cm2. The prepared specimen was subjected to post-curing (post-molding curing: PMC) by placing the specimen in an oven at 170° C. to 180° C. for 4 hours, followed by cooling to measure specimen length using a caliper. Curing shrinkage was calculated from Equation 1:

Curing shrinkage=(Length of mold at 175° C.−Length of specimen)/(Length of mold at 175° C.)×100. [Equation 1]

(3) Glass transition temperature (° C.): Glass transition temperature was measured using a thermo-mechanical analyzer (TMA) under the condition that temperature was increased from 25° C. to 300° C. at a rate of 10° C./min.

(4) Moisture absorption rate (%): The resin compositions prepared in Examples and Comparative Examples were molded under a mold temperature of 170° C.˜180° C., clamp pressure of 70 kgf/cm², transfer pressure of 1000 psi, transfer speed of 0.5˜1 cm/s, and curing time of 120 seconds to obtain cured specimens in a disc shape having a diameter of 50 mm and a thickness of 1.0 mm. The obtained specimens were subjected to post-molding curing by placing the specimens in an oven at 170° C.˜180° C. for 4 hours. After leaving the specimens at 85° C. for 168 hours under a relative humidity of 85 RH %, weight change due to moisture absorption was measured and the moisture absorption rate was calculated by Equation 2:

Moisture absorption rate=(Weight of specimens after moisture absorption−Weight of specimens before moisture absorption)/(Weight of specimens before moisture absorption)×100 [Equation 2]

(5) Flame retardancy: Flame retardancy was measured on a specimen having a ⅛-inch thickness in accordance with UL94 vertical burn testing.

(6) Adhesion (kgf): Copper metal specimens having a suitable size for a mold for measuring adhesion were prepared. The resin compositions prepared in Examples and Comparative Examples were applied to the prepared metal specimens, followed by molding under a mold temperature of 170° C.˜180° C., clamp pressure of 70 kgf/cm², transfer pressure of 1,000 psi, transfer speed of 0.5˜1 cm/s and curing time of 120 seconds to obtain cured specimens. The obtained specimens was subjected to post-molding curing (PMC) by putting the specimens in an oven at 170° C.˜180° C. for four hours. The area of the epoxy resin composition contacting the specimen was 40±1 mm²; and adhesion was measured using a Universal Testing Machine (UTM) for 12 specimens on each measurement and calculated as an average value.

(7) Warpage properties (mil): eTQFP (exposed Thin Quad Flat Package) having a size of 24 mm×24 mm×1 mm (width×length×thickness) including a copper metal component was manufactured by transfer molding the resin composition prepared in Examples and Comparative Examples using a MIPS (Multi Plunger System) mold at 175° C. for 70 seconds. The manufactured package was subjected to post-molding curing at 175° C. for 4 hours, followed by cooling to 25° C. Next, the height difference between a center of an upper surface in diagonal direction and a corner end was measured using non-contact laser equipment. A lower height difference indicates better warpage properties.

(8) Reliability: The eTQFP for evaluation of the warpage properties was dried at 125° C. for 24 hours, followed by heat impact testing through Temperature Cycle Test for 5 cycles (1 cycle refers to leaving the package at −65° C. for 10 minutes, 25° C. for 10 minutes, and 150° C. for 10 minutes). The package was left at 85° C. under a relative humidity of 60% for 168 hours and, then, passed through IR reflow once at 260° C. for 30 seconds. The procedure was repeated three times (pre-condition). The occurrence of cracks in the package was evaluated. Subsequently, the occurrence of delamination between the epoxy resin composition and the lead frame was evaluated using a non-destructive inspection apparatus, C-SAM (Scanning Acoustic Microscopy). Reliability of the package may be impaired if cracks are found outside the package, or delamination between the epoxy resin composition and lead frame is found.

The physical properties of the epoxy resin compositions having the component ratios as listed in Table 1 were measured in accordance with the above evaluation methods. Evaluation results are shown in Table 2.

TABLE 2

| | | | | | | | | Comparative | | |
|---|---|---|---|---|---|---|---|---|---|---|
| | | | Examples | | | | | Examples | | |
| Evaluation Item | | | 1 | 2 | 3 | 4 | 5 | 1 | 2 | 3 |
| Basic | Flowability (inch) | | 50 | 52 | 53 | 56 | 47 | 43 | 42 | 58 |
| physical | Curing shrinkage (%) | | 0.29 | 0.3 | 0.26 | 0.28 | 0.25 | 0.26 | 0.27 | 0.38 |
| properties | Glass transition | | 145 | 142 | 140 | 138 | 145 | 146 | 135 | 125 |
| | temperature (° C.) | | | | | | | | | |
| | Moisture absorption rate | | 0.22 | 0.23 | 0.25 | 0.26 | 0.28 | 0.30 | 0.32 | 0.24 |
| | (%) | | | | | | | | | |
| | Flame retardancy (UL94) | | V-0 | V-0 | V-0 | V-0 | V-0 | V-1 | V-1 | V-0 |
| | Adhesion (kgf) | | 72 | 63 | 57 | 55 | 51 | 43 | 38 | 56 |
| Package | Warpage (mil) | | 2.5 | 2.6 | 2.8 | 2.9 | 2.5 | 2.9 | 3.5 | 5.2 |
| Evaluation | Reliability | Number of | 0/77 | 0/77 | 0/77 | 0/77 | 0/77 | 4/77 | 2/77 | 2/77 |
| | | outside | | | | | | | | |
| | | cracks | | | | | | | | |
| | | Number of | 0/77 | 0/77 | 0/77 | 0/77 | 0/77 | 65/77 | 30/77 | 5/77 |
| | | delamination | | | | | | | | |

For Comparative Examples 1 and 2 wherein n in Formula 3 is 0, that is, the resin compositions prepared using a naphthalene group and phenyl group-containing phenolaralkyl type epoxy resin including only the repeat unit of Formula 1, exhibited low properties in terms of flowability, flame retardancy and reliability. For Comparative Example 3 wherein m in Formula 3 is 0, that is, the resin composition prepared using a naphthalene group and phenyl group-containing phenolaralkyl type epoxy resin having only the repeat unit of Formula 2, exhibited low warpage properties and reliability. In general, when the glass transition temperature increases as in Comparative Example 1, the moisture absorption rate also increases. Conversely, the resin compositions of Examples 1 to 3 prepared using the epoxy resins including a naphthalene group had a high glass transition temperature and low moisture absorption rate, and exhibited excellent flame retardancy, warpage resistance, and reliability.

By way of summation and review, flame retardancy, e.g., a flame retardancy of UL94 V-0, may be important for an epoxy resin composition for encapsulation of a semiconductor device. In order to realize such flame retardancy, an epoxy resin composition for encapsulation of a semiconductor device may be prepared using a halogen flame retardant and an inorganic flame retardant. For example, a general epoxy resin composition for encapsulation of a semiconductor device may be prepared using a brominated epoxy resin and antimony trioxide in order to secure flame retardancy.

Upon combustion or fire, such an epoxy resin composition securing flame retardancy using a halogen flame retardant may generate toxic materials, such as dioxin, difuran and the like, and acidic gases such as hydrogen bromide (HBr), hydrogen chloride (HCl) and the like may be generated upon combustion, and may be harmful to the human body and cause corrosion of wires or lead frames of semiconductor chips.

A non-halogen organic flame retardant and an inorganic flame retardant have been considered. As the organic flame retardant, phosphorus flame retardants, such as phosphagens or phosphoric acid esters, and novel flame retardants, such as nitrogen-containing resins, have been proposed. For nitrogen-containing resins, the resins may have to be used in high amounts to provide flame retardancy. The organic phosphorus flame retardant has excellent flame retardancy and thermal properties, and thus may be suitably used in the epoxy resin composition for encapsulation of a semiconductor device. However, the use of organic phosphorus flame retardant may be undesirable, regardless of no generation of phosphoric acid and polyphosphate through binding with moisture, in view of the possibility of a reduction in reliability from inorganic phosphorus flame retardants.

Non-halogen inorganic flame retardants such as magnesium hydroxide or zinc borate have been considered. However, the epoxy resin composition for encapsulation may exhibit deterioration in curability and continuous moldability in the case of using large amounts of inorganic flame retardants in order to ensure flame retardancy. Accordingly, the added amount of such inorganic flame retardants may be minimized for an epoxy resin and a curing agent constituting the epoxy resin composition for encapsulation to have a certain level of flame retardancy.

Separately, with general use of thin, small scale portable digital devices, a semiconductor package may be formed to be light, thin and miniaturized in order to enhance mounting efficiency per unit volume of the semiconductor package mounted in the devices. As the semiconductor package becomes light, thin and miniaturized, the semiconductor package may suffer from warpage due to difference in coefficient of thermal expansion between the semiconductor chip, lead frame and epoxy resin composition constituting the package, and thermal shrinkage and curing shrinkage of the epoxy resin composition encapsulating the package. Warpage of the package may cause soldering defects upon soldering in a semiconductor post-process and electrical failure resulting from the soldering defects. Therefore, excellent warpage resistance is desired for an epoxy resin composition for encapsulation of a semiconductor device.

In order to enhance warpage properties of epoxy resin compositions, a method of increasing glass transition temperature of epoxy resin compositions, a method of lowering curing shrinkage of epoxy resin compositions, and the like may be considered.

In the course of mounting a semiconductor package on a substrate, the package may be exposed to high temperature (260° C.), whereby the moisture present inside the package may be subjected to rapid volume expansion, which may cause delamination inside the package or fracture outside the package. Accordingly, decreasing the moisture absorption rate of the epoxy resin composition for encapsulation may help ensure reliability. When increasing the glass transition temperature of an epoxy resin composition in order to improve warpage properties, the moisture absorption rate of the epoxy resin composition may be increased, which may cause deterioration in reliability of the package. Therefore, in the case of a package having poor reliability, increase of the glass transition temperature to enhance warpage properties may be restricted.

In order to reduce curing shrinkage of the epoxy resin composition, it may be possible to increase the amount of inorganic fillers having a low coefficient of thermal expansion. However, when the amount of inorganic fillers is increased, the epoxy resin composition may undergo reduction in flowability, limiting an increase of the concentration of inorganic fillers.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present example embodiment as set forth in the following claims.

What is claimed is:

1. An epoxy resin composition for encapsulation of a semiconductor device, the epoxy resin composition comprising:
an epoxy resin including repeat units represented by Formulae 1 and 2; a curing agent; a curing accelerator; and an inorganic filler, 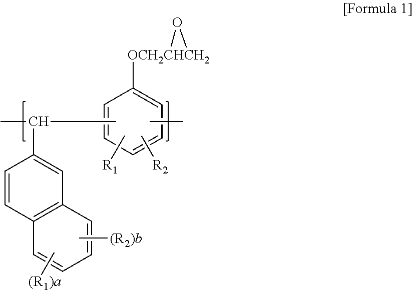
wherein, in Formula 1, R₁ and R₂ are each independently hydrogen or a linear or branched C1-C5 alkyl group, and a and b are each independently an integer from 0 to 7, 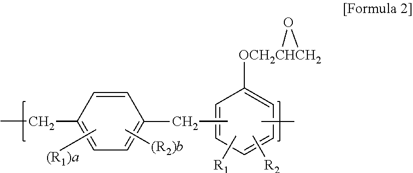
wherein, in Formula 2, R₁ and R₂ are each independently hydrogen or a linear or branched C1-C5 alkyl group, and a and b are each independently an integer from 0 to 4.

2. The epoxy resin composition as claimed in claim 1, wherein the epoxy resin is a naphthalene group and phenyl group-containing phenolaralkyl type epoxy resin represented by Formula 3: 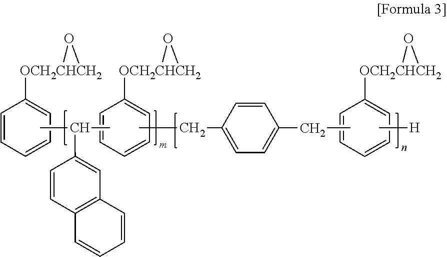
wherein, in Formula 3, m and n are each independently on average from 1 to 10.

3. The epoxy resin composition as claimed in claim 2, wherein, in Formula 3, m/(m+n) ranges from about 0.1 to about 0.9, and n/(m+n) ranges from about 0.1 to about 0.9.

4. The epoxy resin composition as claimed in claim 1, wherein the epoxy resin comprises the repeat units of Formulae 1 and 2 in a molar ratio of about 10:90 to about 90:10.

5. The epoxy resin composition as claimed in claim 1, wherein the epoxy resin comprises the repeat units of Formulae 1 and 2 in a molar ratio of about 90:10 to about 30:70.

6. The epoxy resin composition as claimed in claim 1, wherein the epoxy resin has an epoxy equivalent weight of about 100 g/eq. to about 250 g/eq., and a melt viscosity of about 0.1 poise to about 3 poise at 150° C.

7. The epoxy resin composition as claimed in claim 1, wherein the epoxy resin is present in an amount of about 1 wt % to about 13 wt % in the epoxy resin composition.

8. The epoxy resin composition as claimed in claim 1, wherein the curing agent comprises at least one of a phenolaralkyl type phenol resin and a xylok type phenol resin.

9. The epoxy resin composition as claimed in claim 1, comprising: about 1 wt % to about 13 wt % of the epoxy resin; about 1.5 wt % to about 10 wt % of the curing agent; about 0.001 wt % to about 1.5 wt % of the curing accelerator; and about 70 wt % to about 94 wt % of the inorganic filler.

10. The epoxy resin composition as claimed in claim 1, further comprising: a second epoxy resin selected from the group of a phenolaralkyl type epoxy resin having a biphenyl backbone represented by Formula 4, a biphenyl type epoxy resin represented by Formula 5, and a xylok type epoxy resin represented by Formula 6, 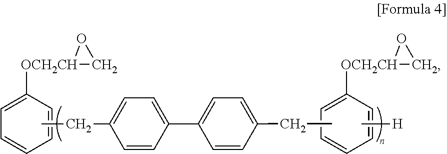
wherein, in Formula 4, n is a value from 1 to 7 on average, 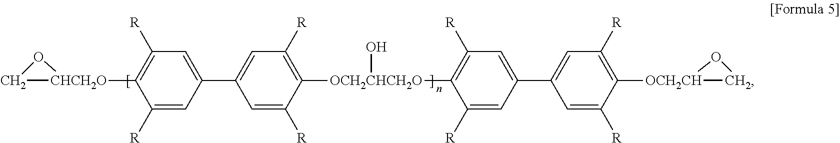
wherein, in Formula 5, R is a C1 to C4 alkyl group, and n is a value from 0 to 7 on average, 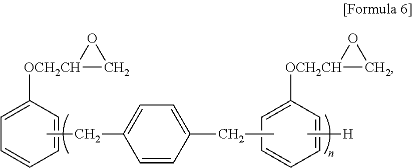
wherein, in Formula 6, n is a value from 1 to 7 on average.

11. The epoxy resin composition as claimed in claim 1, wherein the epoxy resin and the curing agent are present in an amount such that an equivalent weight ratio of an epoxy group in the epoxy resin to a phenolic hydroxyl group in the curing agent ranges from about 0.5:1 to about 2:1.

12. The epoxy resin composition as claimed in claim 1, wherein the curing accelerator is a tertiary amine, an organometallic compound, an organophosphorus compound, an imidazole compound, or a boron compound.

13. The epoxy resin composition as claimed in claim 1, wherein the inorganic filler includes about 50 wt % to about 99 wt % of fused spherical silica having an average particle diameter of about 5 μm to about 30 μm and about 1 wt % to about 50 wt % of fused spherical silica having an average particle diameter of about 0.001 μm to about 1 μm.

14. A semiconductor device encapsulated using the epoxy resin composition as claimed in claim 1.
